(19) United States
(12) Patent Application Publication
(10) Pub. No.: US 2026/0127861 A1
(43) Pub. Date: May 7, 2026

(54) METHODS OF AND SYSTEMS FOR TRAINING MACHINE LEARNING PROCESSES USING MEDICAL IMAGERY

(71) Applicant: Anumana, Inc., Cambridge, MA (US)

(72) Inventor: Arjun Puranik, San Jose, CA (US)

(73) Assignee: Anumana, Inc., Cambridge, MA (US)

(21) Appl. No.: 19/379,008

(22) Filed: Nov. 4, 2025

Related U.S. Application Data
(60) Provisional application No. 63/715,700, filed on Nov. 4, 2024.

(51) Int. Cl. G06V 10/774; G06T 5/40; G06T 5/70; G06T 5/92; G06T 7/12

(52) U.S. Cl. CPC G06V 10/774; G06T 5/40; G06T 5/70; G06T 5/92; G06T 7/12; G06T 2207/10116; G06T 2207/10132; G06T 2207/20032; G06T 2207/20072; G06T 2207/20081

(57) ABSTRACT

A computing device configured to receive at least a radiological image, encode, using an encoding module, a low-dimensional image as a function of the radiological image, wherein the encoding module is configured to preprocess the radiological image, generate a segmented representation of the radiological image by applying edge detection to the preprocessed radiological image, generate a reduced contour set by performing contour simplification and dimensionality reduction on the segmented representation, and generate a color-coded contour map by coloring coding one or more contours of the reduced contour set, and input the low-dimensional image into at least a machine learning process as training data.

### CROSS-REFERENCE TO RELATED APPLICATIONS

This application claims the benefit of priority of U.S. Provisional Patent Application Ser. No. 63/715,700, filed on Nov. 4, 2024, and titled “METHODS AND SYSTEMS FOR TRAINING MACHINE LEARNING PROCESSES USING MEDICAL IMAGERY,” which is incorporated by reference herein in its entirety.

### FIELD OF THE INVENTION

The present invention generally relates to the field of medical imagery. In particular, the present invention is directed to methods and systems for training machine learning processes using medical imagery.

### BACKGROUND

Medical radiological imagery has existed for decades and hospitals have access to these data. Machine learning using these data would be advantageous.

### SUMMARY OF THE DISCLOSURE

In another aspect, a system includes at least a computing device configured to receive at least a radiological image, encode, using an encoding module, a low-dimensional image as a function of the radiological image, wherein the encoding module is configured to preprocess the radiological image, generate a segmented representation of the radiological image by applying edge detection to the preprocessed radiological image, generate a reduced contour set by performing contour simplification and dimensionality reduction on the segmented representation, and generate a color-coded contour map by coloring coding one or more contours of the reduced contour set, and input the low-dimensional image into at least a machine learning process as training data.

In an aspect, a method includes using at least a computing device to receive at least a radiological image, encode, using an encoding module, a low-dimensional image as a function of the radiological image, wherein the encoding module is configured to preprocess the radiological image, generate a segmented representation of the radiological image by applying edge detection to the preprocessed radiological image, generate a reduced contour set by performing contour simplification and dimensionality reduction on the segmented representation, and generate a color-coded contour map by coloring coding one or more contours of the reduced contour set, and input the low-dimensional image into at least a machine learning process as training data.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram showing a system for training of machine learning processes using medical imagery;

FIG. 2 illustrates an exemplary radiological image;

FIG. 3 illustrates an exemplary low-dimensional image;

FIG. 4 illustrates exemplary machine learning processes according to some embodiments;

FIG. 5A represents an exemplary neural network;

FIG. 5B illustrates exemplary machine learning process;

FIG. 6A is an exemplary illustration of a graphical user interface displaying image data;

FIG. 6B is an exemplary illustration of a graphical user interface displaying image data including a target structure;

FIG. 7 is a flow diagram showing a method of training of machine learning processes using medical imagery; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In some embodiments, aspects relate to contour-based encoding with limited color and complexity: In some cases, each radiological image (e.g., TEE frame (and by extension, the CT mesh-derived frames)) is represented with contours-lines or curves-on a white background. In some cases, by limiting these contours to, for example, 20 colors, and keeping the curves relatively simple, the dimensionality of the resulting image data is drastically reduced. In some versions, this reduction facilitates faster, more efficient analysis while maintaining essential structural information required for self-supervised learning (SSL).

In some embodiments, aspects relate to low-dimensional space for SSL training: In some embodiments, low-dimensional images, e.g., the contours on a white background, define a space that is much simpler and lower-dimensional than typical medical images, yet specific enough to be a valid representation of relevant anatomical structures. In some versions, given this compact representation, models could focus more directly on learning meaningful relationships between anatomical structures without noise and high complexity of real images.

In embodiments, aspects relate to high volume of annotated data. In some cases, electronic health records may be used for training, for instance access to a corpus of radiological images from hospitals. Some large hospital systems have access to radiological images that include ˜100,000 or more instances each of cardiac and esophageal tissue (e.g., ultrasound and CT). In some cases, these large bodies of radiological images may be used for training. Converting these images into low dimensional space, as described throughout, can be used for SSL, necessary for training on such large data sets, where models learn structure and relationships without manual labels.

In some embodiments, aspects relate to universal applicability across medical imaging: In some embodiments, since ultrasound images for many organs often have a structured, contour-rich appearance, this encoding approach may be used for ultrasound applications of other body parts, not just TEE or cardiac imaging. Additionally, CT mesh segmentation-derived frames provide a consistent space applicable to various organs. Accordingly, in some cases, this contour-based, low-dimensional approach might not only advance cardiac imaging but potentially become a generalizable model across broader anatomical structures.

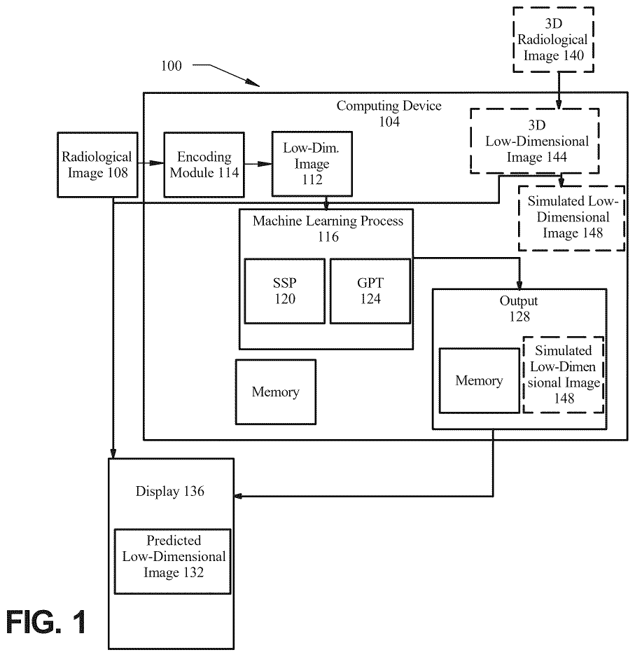

Referring now to FIG. 1, an exemplary embodiment of a system 100 for training machine learning processes using medical imagery is illustrated. System 100 includes a computing device 104. Computing device includes a processor communicatively connected to a memory. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Further referring to FIG. 1, Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for distribution of tasks or memory between computing devices. Computing device 104 may be implemented, as a non-limiting example, using a “shared nothing” architecture.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may be configured to receive at least a radiological image 108. As used in this disclosure, a “radiological image” is a representation of human anatomy. Radiological image 108 may include a two dimensional (2D) or a three dimensional image (3D). Radiological image may include or be a component of a radiological video, e.g., fluoroscopy, ultrasound, computed tomography.

Still referring to FIG. 1, in some embodiments, at least a radiological image 108 may include at least an ultrasound image. In some cases, at least an ultrasound image may include one or more of a transthoracic echocardiogram (TTE) image, a transesophageal echocardiogram (TEE) image, an intracardiac echocardiogram (ICE) image, and a point of care ultrasound (POCUS) image.

Still referring to FIG. 1, in some embodiments, at least a radiological image 108 may include one or more of a computed tomography image, a magnetic resonance imaging image, an X-ray image, a fluoroscopy image, photoacoustic image, and the like.

With continued reference to FIG. 1, computing device 104 may encode at least a low-dimensional image 112. At least a low-dimensional image 112 may be encoded as a function of at least a radiological image 108. As used herein, “encode” is to generate a structured representation of anatomical information from input data. In some embodiments, encode may include transforming at least a radiological image 108 into low-dimensional image 112 by extracting anatomical boundaries, representing those boundaries as simplified lines with constrained line parameters, assigning color identifiers to those lines, and producing a compressed anatomical representation that may be provided as a standardized input to at least a machine learning process 116. As used in this disclosure, a “low-dimensional image” is a representation with a constrained dimensionality. For example, a low-dimensional image may include an image with a background (e.g., black or white) and a plurality of lines (e.g., curves) of different colors; the low-dimensional image may have constrained number of total lines, constrained number of line parameters per line, and/or a constrained number of line colors.

With continued reference to FIG. 1, low-dimensional image 112 may represent a radiological image 108. Low dimensional image 112 may comprise at least a line. As used in this disclosure, a “line” is either a straight line or a curved line. In this disclosure, “line,” “curve,” and “contour” may each be used interchangeably, although curves and contours are species of lines. A line may be represented by vectors, splines, curves, and the like. A line may be defined by line parameters. The total number of line parameters that define a line may be constrained, for instance, to limit dimensionality.

With continued reference to FIG. 1, in some embodiments, computing device 104 may generate low-dimensional image 112 by applying an encoding process that converts at least a radiological image 108 into one or more vectors that describe one or more lines. In some embodiments, the encoding process may identify anatomical boundaries, instrument boundaries, and/or other structures present in at least a radiological image 108 and may express those boundaries as line representations having associated line parameters. In some embodiments, each line in low-dimensional image 112 may be stored as a vector that encodes position, curvature, orientation, and/or length of that line within at least a radiological image 108, rather than storing every pixel of at least a radiological image 108. In some embodiments, computing device 104 may constrain how many vectors are used, how many line parameters are used per vector, and/or how many distinct lines are included in low-dimensional image 112 so that low-dimensional image 112 may be represented compactly. In some embodiments, such constraining of representation may reduce dimensionality relative to at least a radiological image 108 while retaining salient structural information for downstream interpretation, classification, prediction, or generation by one or more machine learning models executed by computing device 104.

With continued reference to FIG. 1, a “vector” as defined in this disclosure is a data structure that represents one or more a quantitative values and/or measures with direction. Vectors may also represent magnitude and direction. Such vector and/or embedding may include and/or represent an element of a vector space; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute 1 as derived using a Pythagorean norm:

$$l = \sqrt{{\sum }_{i = 0}^{n} {a}_{i}^{2}} ,$$

where ai is attribute number i of the vector. Scaling and/or normalization may function to make vector comparison independent of absolute quantities of attributes, while preserving any dependency on similarity of attributes. A two-dimensional subspace of a vector space may be defined by any two orthogonal vectors contained within the vector space. Two-dimensional subspace of a vector space may be defined by any two orthogonal and/or linearly independent vectors contained within the vector space; similarly, an n-dimensional space may be defined by n vectors that are linearly independent and/or orthogonal contained within a vector space. A vector's “norm’ is a scalar value, denoted ∥a∥ indicating the vector's length or size, and may be defined, as a non-limiting example, according to a Euclidean norm for an n-dimensional vector a as:

$$‖ a ‖ = \sqrt{{\sum }_{i = 0}^{n} {a}_{i}^{2}}$$

In an embodiment, and with continued reference to FIG. 1, each line or contour may be represented by a dimension of a vector space; as a non-limiting example, each element of a vector may include a number representing an enumeration of co-occurrences of contours represented by the vector. Alternatively, or additionally, dimensions of vector space may not represent distinct, in which case elements of a vector representing a contour may have numerical values that together represent a geometrical relationship to a vector representing a radiological imagery, wherein the geometrical relationship represents and/or approximates a semantic relationship between the radiological imagery and the contour. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below.

Any vectors as described herein may be scaled, such that each vector represents each attribute along an equivalent scale of values. In an embodiment associating contours to one another as described above may include computing a degree of vector similarity between a vector representing each radiological imagery and a vector representing another low-dimensional image; vector similarity may be measured according to any norm for proximity and/or similarity of two vectors, including without limitation cosine similarity. As used in this disclosure “cosine similarity” is a measure of similarity between two-non-zero vectors of a vector space, wherein determining the similarity includes determining the cosine of the angle between the two vectors. Cosine similarity may be computed as a function of using a dot product of the two vectors divided by the lengths of the two vectors, or the dot product of two normalized vectors. For instance, and without limitation, a cosine of 0° is 1, wherein it is less than 1 for any angle in the interval (0,π) radians. Cosine similarity may be a judgment of orientation and not magnitude, wherein two vectors with the same orientation have a cosine similarity of 1, two vectors oriented at 90° relative to each other have a similarity of 0, and two vectors diametrically opposed have a similarity of −1, independent of their magnitude. As a non-limiting example, vectors may be considered similar if parallel to one another. As a further non-limiting example, vectors may be considered dissimilar if orthogonal to one another. As a further non-limiting example, vectors may be considered uncorrelated if opposite to one another. Additionally, or alternatively, degree of similarity may include any other geometric measure of distance between vectors.

With continued reference to FIG. 1, low-dimensional image 112 may have a constrained dimensionality. As used in this disclosure, “dimensionality” refers to a qualified substantive's (e.g., image's) number of defining features, parameters, qualities, variables, characteristics, or the like. As used in this disclosure, a “constrained dimensionality” refers to a qualified substantive (e.g., image) being able to be defined by a limited number of defining features, parameters, qualities, variables, characteristics, or the like. Constrained dimensionality may be limited by a constrained number of a certain type of defining features, parameters, qualities, variables, characteristics, or the like. For example, a low-dimension image may have constrained dimensionality by comprising a constrained number of lines or lines of a constrained number of colors (e.g., 20).

Still referring to FIG. 1, in some embodiments, constrained dimensionality may include one or more of (a) a constrained number of lines (e.g., 10, 20, 30, 40, 50, 100, 500, 1000, or the like); (b) a constrained number of line parameters (e.g., 10, 20, 30, 40, 50, 100, 500, 1000, or the like); and (c) a constrained number of line colors (e.g., 10, 20, 30, 40, 50, 100, 500, 1000, or the like). In some cases, at least a line may include at least a curve comprising at least a line parameter and at least a line color.

Still referring to FIG. 1, in some embodiments, encoding at least a low-dimensional image 112 may include one or more processes comprising: (1) image processing; (2) image segmentation; (3) contour simplification and dimensional reduction, (4) color coding of lines, and (5) validation. Each of these processes are described briefly below with reference to an ultrasound image being used for a radiological image 108. In some embodiments, encoding at least a low-dimensional image 112 may be performed by an encoding module 114 executed by computing device 104. As used herein, an “encoding module” is software that generates a structured representation of anatomical information from input data. In some embodiments, the encoding module 114 may include one or more of an image processing module, a segmentation module, a contour simplification process that generates a reduced contour set, a color-coding process that generates a color-coded contour map, and a validation module as described in this disclosure. Encoding module 114 may perform any of the encoding processes or functions described herein.

With continued reference to FIG. 1, image processing may include an image preprocessing stage applied to at least a radiological image 108. As used herein, “image preprocessing” is a set of operations that prepare at least a radiological image for contour extraction and subsequent generation of low-dimensional image by reducing noise, improving contrast, and standardizing intensity characteristics. In some embodiments, an ultrasound embodiment of at least a radiological image 108 may include speckle, acoustic shadowing, and other modality-specific artifacts that interfere with accurate detection of anatomical boundaries. In some embodiments, computing device 104 may apply noise reduction to at least a radiological image 108, where noise reduction may include applying a median filter. As used herein, “noise reduction” is a process that modifies input data to suppress unwanted variation that does not correspond to underlying structure. As used herein, a “median filter” is an algorithm that replaces an intensity value at a pixel location with a median intensity value taken from a defined neighborhood around that pixel location. As used herein, an “intensity value” is a numeric value that represents the measured signal at a location in at least a radiological image. For example, a brightness value in a two-dimensional frame or a density value in a computed tomography slice. As used herein, a “defined neighborhood” is a set of pixel locations surrounding a given pixel location within a fixed spatial window. For example, a 3×3, 5×5, or 7×7 square region centered on that pixel location. In some embodiments, the median filter may sort the intensity values within the defined neighborhood and select the median of those values, and that median may then replace the original intensity value at the center location. In some embodiments, because the median is less sensitive to isolated extreme values than an arithmetic mean, the median filter may suppress isolated bright or dark spikes caused by noise while preserving sharp transitions at anatomical boundaries that computing device 104 may later represent as one or more lines in low-dimensional image 112. In some embodiments, using a median filter may suppress isolated high-intensity or low-intensity speckle points without excessively blurring edges corresponding to anatomical structures such as chamber walls, valve leaflets, or catheter shafts, thereby supporting more stable downstream contour detection.

With continued reference to FIG. 1, in some embodiments, computing device 104 may apply contrast enhancement to at least a radiological image 108. As used herein, “contrast enhancement” is modification of an intensity distribution of an image frame to increase separability between adjacent structures. In some embodiments, contrast enhancement may include histogram equalization. As used herein, “histogram equalization” is a process that redistributes pixel intensities so that darker regions are made more distinguishable from adjacent brighter regions and vice versa. In some embodiments, histogram equalization may improve visual salience of thin anatomical features that may otherwise appear faint in an ultrasound embodiment of at least a radiological image 108, such as leaflet tissue or the wall of a left atrial appendage, which may make contours of those features easier for computing device 104 to detect and represent as one or more lines in low-dimensional image 112. In some embodiments, computing device 104 may apply localized or adaptive histogram equalization so that deeper regions of an ultrasound embodiment of at least a radiological image 108, which may be dimmer due to attenuation, are enhanced without oversaturating shallow regions closer to the probe.

With continued reference to FIG. 1, in some embodiments, computing device 104 may apply normalization to at least a radiological image 108. As used herein, “normalization” is adjustment of one or more numeric properties of at least a radiological image 108 so that multiple images conform to a common baseline for downstream processing. In some embodiments, normalization may include standardizing pixel intensity values across multiple ultrasound embodiments of at least a radiological image 108 so that different acquisitions are expressed on a consistent numeric scale. In some embodiments, normalization may compensate for differences in gain settings, depth settings, probe type, and/or manufacturer so that frames acquired from different ultrasound devices or procedural environments are more uniform. In some embodiments, by providing noise-reduced, contrast-enhanced, and normalized data to downstream contour extraction, computing device 104 may improve stability and repeatability of the lines that are ultimately recorded in low-dimensional image 112.

With continued reference to FIG. 1, in some embodiments, computing device 104 may execute an image processing module during the image preprocessing stage of encoding at least a low-dimensional image 112. As used herein, an “image processing module” is software that receives at least a radiological image and outputs a processed image. The processed image may have undergone one or more of noise reduction, contrast enhancement, and normalization as described above. In some embodiments, the image processing module may perform noise reduction by suppressing speckle and other ultrasound-specific artifacts while preserving anatomical edges, may perform contrast enhancement by redistributing pixel intensities (for example, via histogram equalization) to increase separability between adjacent anatomical structures, and may perform normalization by standardizing pixel intensity ranges and gain characteristics across different acquisitions of at least a radiological image 108 so that downstream processing receives a consistent numeric representation. In some embodiments, the image processing module may include one or more machine learning models and/or deterministic filters configured to identify speckle patterns, preserve boundary gradients at anatomical interfaces such as chamber walls or catheter shafts, adjust local contrast in deeper and shallower regions differently, and apply a standardized scaling of intensities across frames of at least a radiological image 108, such that an output of the image processing module is suitable for downstream contour extraction and representation as one or more lines in low-dimensional image 112. In some embodiments, the image processing module may be trained and/or tuned using training data that may include ultrasound embodiments of at least a radiological image 108 paired with corresponding target frames that exhibit reduced speckle, enhanced boundary definition, and normalized intensity scaling, and training of the image processing module may adjust internal parameters such as learned filter weights, node activations, region-specific gain parameters, contrast redistribution thresholds, and normalization scale factors so that the image processing module may reliably generate processed images that preserve clinically meaningful structures for subsequent encoding into low-dimensional image 112.

With continued reference to FIG. 1, in some embodiments, encoding at least a low-dimensional image 112 may include segmentation of key structures within at least a radiological image 108. As used herein, “segmentation” is identification, isolation, and delineation of anatomical structures and/or device structures within at least a radiological image. In some embodiments, computing device 104 may execute a segmentation module to perform segmentation. As used herein, a “segmentation module” is software that receives at least a radiological image and outputs a segmented representation that distinguishes one or more anatomical structures and/or interventional tools from surrounding background. In some embodiments, the segmentation module may apply one or more of edge detection, contour extraction, and model-based segmentation.

With continued reference to FIG. 1, in some embodiments, the segmentation module may apply edge detection to at least a radiological image 108. As used herein, “edge detection” is a process that identifies transition boundaries in an image where intensity, density, or signal characteristics change sharply. In some embodiments, edge detection may include use of one or more gradient-based or second-derivative-based operators, such as Sobel, Canny, or Laplacian-based edge detection. In some embodiments, the segmentation module may apply such operators to detect boundaries that correspond to anatomical contours, such as chamber walls, vessel walls, structural heart borders, airway or esophageal walls, bony structures, and/or device or catheter surfaces visible in at least a radiological image 108. In some embodiments, detected edges may serve as candidates for one or more lines that may be stored in low-dimensional image 112.

With continued reference to FIG. 1, in some embodiments, the segmentation module may perform contour detection and extraction based on detected edges. As used herein, “contour detection and extraction” is a process that groups edge responses into continuous curves and/or closed boundaries representing specific anatomical regions in at least a radiological image. In some embodiments, the segmentation module may aggregate adjacent edge responses that satisfy continuity and curvature criteria to generate contours that follow anatomical boundaries. In some embodiments, such contours may outline, for example, a cardiac chamber, a vascular lumen, a skeletal boundary, or a tool profile. In some embodiments, these contours may then be explicitly represented as one or more lines with associated line parameters in low-dimensional image 112.

With continued reference to FIG. 1, in some embodiments, the segmentation module may apply model-based segmentation to at least a radiological image 108. As used herein, “model-based segmentation” is segmentation performed by one or more machine learning processes that are configured to output a classification or mask for one or more anatomical structure. In some embodiments, model-based segmentation may include one or more deep learning models configured to output a pixel-level or voxel-level label map that distinguishes a structure of interest from surrounding regions. In some embodiments, such deep learning models may include, for example, an encoder-decoder architecture configured to receive at least a radiological image 108 and output at least one binary mask or multi-class mask that outlines one or more structures such as a cardiac chamber, great vessel, valve annulus, airway, gastrointestinal structure, interventional device, or bony landmark. In some embodiments, a binary mask may be an output in which pixels or voxels belonging to a target structure are marked as belonging to that structure and all other pixels or voxels are marked as background. In some embodiments, model-based segmentation may be performed by any machine learning process described in this disclosure.

With continued reference to FIG. 1, in some embodiments, output of the segmentation module may be referred to as a segmented representation. As used herein, a “segmented representation” is data generated by the segmentation module that (i) identifies anatomical structures and/or device structures within at least a radiological image, (ii) associates each identified structure with one or more contours that follow a boundary of that structure, and (iii) provides one or more masks that distinguish that structure from surrounding regions. In some embodiments, the segmented representation may include one or more contours suitable to be encoded as lines in low-dimensional image 112 together with information linking each of those lines to a specific anatomical structure.

With continued reference to FIG. 1, in some embodiments, the segmentation module may be trained and/or tuned using training data that may include sets of radiological image samples paired with expert-annotated segmentations that indicate true anatomical boundaries and/or device boundaries, and training of the segmentation module may adjust internal parameters such as learned filter weights, convolutional kernel weights, node activation thresholds, contour continuity thresholds, and region-merging criteria so that the segmentation module may reliably output edge maps, contours, and binary or multi-class masks that accurately correspond to anatomical and/or device structures across different imaging modalities and acquisition conditions.

With continued reference to FIG. 1, in some embodiments, encoding at least a low-dimensional image 112 may include contour simplification and dimensionality reduction applied to a segmented representation. As used herein, “contour simplification” is a process of modifying one or more contours in an image so that each contour is represented using fewer points while preserving clinically relevant geometric structure. In some embodiments, computing device 104 may apply a contour approximation algorithm configured to iteratively remove intermediate points from a contour and retain points that contribute most to overall shape. In some embodiments, such a contour approximation algorithm may include an algorithm of the Douglas-Peucker type that evaluates a deviation distance between an original contour and a simplified contour, and removes contour points that fall below a deviation threshold. In some embodiments, computing device 104 may select the deviation threshold so that gradual curvature of an anatomical boundary (for example, a chamber wall boundary, vessel wall boundary, or lumen boundary identified in the segmented representation) is retained, while small, high-frequency variations that are attributable to imaging noise and/or acquisition artifact are discarded. In some embodiments, contour simplification may produce a set of simplified lines that capture the gross geometry of each anatomical boundary without storing all original points from the segmented representation.

With continued reference to FIG. 1, in some embodiments, computing device 104 may apply dimensionality reduction to simplified lines produced by contour simplification so that the simplified lines are expressed in a compact numeric form suitable for storage and downstream machine learning. As used herein, “dimensionality reduction” is transformation of data describing one or more contours from a higher-dimensional coordinate description into a lower-dimensional description that preserves salient geometric relationships. In some embodiments, computing device 104 may apply a dimensionality reduction technique configured to represent one or more contours using a reduced set of parameters. In some embodiments, such a dimensionality reduction technique may include Principal Component Analysis (PCA) configured to project coordinates of points on a contour into a lower-dimensional subspace that captures dominant modes of variation in contour position and shape. In some embodiments, such a dimensionality reduction technique may include resampling a contour to a predetermined number of points, normalizing position and scale of that contour relative to a defined reference frame, and encoding that normalized contour as a fixed-length vector. In some embodiments, computing device 104 may further apply nonlinear manifold mapping techniques to preserve relative spatial relationships among multiple anatomical structures in the segmented representation while reducing the total number of stored parameters. In some embodiments, by expressing each contour using a limited number of parameters, computing device 104 may constrain the total number of line parameters used to describe low-dimensional image 112.

With continued reference to FIG. 1, in some embodiments, output of contour simplification and dimensionality reduction may be referred to as a reduced contour set. As used herein, a “reduced contour set” is data that (i) comprises one or more simplified lines derived from the segmented representation, (ii) represents each simplified line using a constrained number of line parameters, and (iii) preserves spatial relationships among anatomical structures identified in at least a radiological image. In some embodiments, the reduced contour set may be written directly into low-dimensional image 112 as one or more lines together with corresponding line parameters. In some embodiments, the reduced contour set may allow computing device 104 to represent anatomical boundaries and/or device boundaries using fewer stored values than would be required to store at least a radiological image 108, while retaining sufficient structural detail for downstream classification, tracking, prediction, or generation by one or more machine learning processes executed by computing device 104.

With continued reference to FIG. 1, in some embodiments, encoding at least a low-dimensional image 112 may include applying color coding to one or more contours of a reduced contour set. In some embodiments, computing device 104 may assign a color identifier to each contour in the reduced contour set so that each anatomical structure, device structure, or region of interest is visually distinguishable in low-dimensional image 112. In some embodiments, computing device 104 may reference a predefined color map that associates each anatomical structure category with a designated color. As used herein, a “color map” is an association between a structure label and a color identifier selected from a set of colors. In some embodiments, the color identifier may be represented as a color index, a color class ID, or an RGB triplet value. In some embodiments, the predefined color map may explicitly constrain the total number of distinct colors that are used to label contours in low-dimensional image 112. In some embodiments, computing device 104 may constrain the number of allowed colors to a fixed upper bound (for example, 20), where different anatomical structures and device structures are mapped to distinct color identifiers from that limited set, and one or more reserved color identifiers are allocated to ambiguous regions or regions flagged as artifact in the segmented representation. In some embodiments, constraining the number of colors in this manner may contribute to constraining dimensionality of low-dimensional image 112, because each contour in the reduced contour set may be stored using a limited set of parameters (for example, contour coordinates and a single color identifier) rather than full pixel intensities of at least a radiological image 108.

With continued reference to FIG. 1, in some embodiments, computing device 104 may generate a render in which contours from the reduced contour set are drawn on a plain, uniform background. In some embodiments, computing device 104 may render each simplified line of the reduced contour set using its assigned color from the color map, and may render the background as a uniform white or near-white field that does not itself encode anatomical texture, grayscale intensity, depth shading, or speckle. In some embodiments, drawing the reduced contour set against a uniform background may produce a sparse, symbolic depiction of anatomical boundaries without including raw pixel-level information from at least a radiological image 108. In some embodiments, this depiction may correspond to at least a low-dimensional image 112. In some embodiments, at least a low-dimensional image 112 may therefore consist of colored lines representing anatomical boundaries or device boundaries, where each line is defined by line parameters and associated with a color identifier from the color map, and where the background is visually blank. In some embodiments, this approach may allow computing device 104 to encode structural relationships between anatomical structures (for example, spatial adjacency of a chamber boundary and a procedural tool) using only a set of colored contours, which may be substantially lower in dimensionality than the original pixel array or voxel array of at least a radiological image 108.

With continued reference to FIG. 1, in some embodiments, output of color assignment and rendering may be referred to as a color-coded contour map. As used herein, a “color-coded contour map” is a representation in which each simplified line of the reduced contour set is drawn in a color associated with an identified structure, and all contours are drawn against a uniform background that omits original intensity content of at least a radiological image. In some embodiments, the color-coded contour map may be stored directly as part of low-dimensional image 112. In some embodiments, the color-coded contour map may include, for each contour, a set of line parameters (for example, control points, spline coefficients, or sampled coordinates), a structure identifier (for example, left ventricle, catheter, airway wall), and a color identifier selected from the predefined color map. In some embodiments, computing device 104 may use the color-coded contour map as an input to one or more machine learning processes described in this disclosure, where those machine learning processes may classify anatomical context, predict spatial relationships between structures, perform procedural guidance, generate simulated future anatomical views, and/or generate synthetic imaging frames without requiring full-resolution, modality-specific raw data.

With continued reference to FIG. 1, in some embodiments, encoding at least a low-dimensional image 112 may include a validation stage that evaluates whether anatomical information encoded in low-dimensional image 112 is clinically meaningful. In some embodiments, computing device 104 may execute a validation module. As used herein, “validate” is to evaluate whether an output satisfies one or more expected criteria. In some embodiments, validate may include determining whether low-dimensional image 112 preserves anatomically relevant structure from at least a radiological image 108 to a degree sufficient for use by at least a machine learning process 116. As used herein, a “validation module” is software that receives a low-dimensional image and at least a radiological image and outputs a validation result indicating whether the low-dimensional image preserves one or more clinically relevant anatomical features of the radiological image. In some embodiments, the validation module may compare a color-coded contour map associated with low-dimensional image 112 against a corresponding region of at least a radiological image 108 and/or against a segmented representation generated by the segmentation module. In some embodiments, the validation module may determine whether a boundary represented as a line in low-dimensional image 112 spatially aligns with an anatomical boundary in at least a radiological image 108 within a tolerance. In some embodiments, such tolerance may include a maximum allowed deviation between a simplified line from a reduced contour set and an anatomic interface visible in at least a radiological image 108. In some embodiments, the validation module may compute one or more metrics such as average surface distance, maximum surface distance, overlap between a mask derived from low-dimensional image 112 and a mask in the segmented representation, continuity of a contour across expected anatomical regions, or presence/absence of a required structure. In some embodiments, a required structure may include, for example, a boundary of a target chamber, a procedural tool, or an access path that is clinically relevant to a planned or ongoing intervention. In some embodiments, if the validation module determines that low-dimensional image 112 omits a required structure or exceeds an allowed deviation threshold, computing device 104 may discard, flag, or reprocess the affected frame before passing low-dimensional image 112 to downstream machine learning processes.

With continued reference to FIG. 1, in some embodiments, the validation module may also support annotation and iterative refinement of low-dimensional image 112. As used herein, “annotation” is association of one or more structures in a low-dimensional image with human-provided or algorithmically generated labels that describe anatomical identity, procedural relevance, or quality status. In some embodiments, annotation may include assigning a structure identifier (for example, left atrium, esophagus, catheter shaft) to a given line in low-dimensional image 112, confirming that the color assigned by the predefined color map is correct for that structure, and marking whether the representation is acceptable for downstream machine learning use. In some embodiments, annotation may be generated manually by an expert reviewer, semi-automatically by prompting an operator to correct suggested labels from computing device 104, and/or automatically by computing device 104 using outputs of the segmentation module and the validation module. In some embodiments, annotation may be used for quality control of low-dimensional image 112 and may also be used as training data for one or more machine learning processes described in this disclosure.

With continued reference to FIG. 1, in some embodiments, computing device 104 may apply self-supervised learning within the validation stage. As used herein, “self-supervised learning” is a machine learning process in which a computing device trains one or more models using supervisory signals derived from the data themselves rather than relying exclusively on externally provided ground-truth annotations. In some embodiments, computing device 104 may train an encoder-decoder model to reconstruct at least a radiological image 108 or to reconstruct a segmented representation from low-dimensional image 112, and differences between the reconstruction and an observed reference, such as the original radiological image, may be used by the validation module to score adequacy of low-dimensional image 112. In some embodiments, the validation module may generate an adequacy score to determine whether low-dimensional image 112 preserves clinically relevant anatomical structure. As used herein, an “adequacy score” is a numeric or categorical measure that indicates whether a low-dimensional image preserves anatomical structure to a threshold. In some embodiments, computing device 104 may train an encoder-decoder model to reconstruct at least a radiological image 108 or to reconstruct a segmented representation from low-dimensional image 112, and may compare that reconstruction to a corresponding reference, such as at least a radiological image 108 or the segmented representation generated for that frame. In some embodiments, the validation module may compute the adequacy score as a function of one or more similarity metrics between the reconstruction and the reference, where such similarity metrics may include a pixel-wise or voxel-wise difference measure, an overlap measure between anatomical boundaries, a distance measure between corresponding contours, and/or a structural similarity measure between regions of interest. In some embodiments, a higher adequacy score may indicate that low-dimensional image 112 encodes anatomical boundaries and spatial relationships closely enough that the encoder-decoder model can accurately recover the reference, whereas a lower adequacy score may indicate loss of clinically relevant structure, prompting computing device 104 to flag, reject, or regenerate that instance of low-dimensional image 112 before providing it to at least a machine learning process 116.

With continued reference to FIG. 1, in some embodiments, computing device 104 may additionally apply contrastive learning, in which two or more related samples (for example, two low-dimensional image 112 representations of anatomically similar views acquired at different times or angles) are encouraged to map to similar internal feature embeddings, while unrelated samples are encouraged to map to dissimilar internal feature embeddings. In some embodiments, contrastive learning signals may allow computing device 104 to detect when low-dimensional image 112 is inconsistent with its source anatomy because inconsistent samples may not cluster with anatomically similar samples in the model's learned embedding space. In some embodiments, annotation corrected or approved by an expert may be fed back to computing device 104 so that internal parameters of the validation module and/or segmentation module are refined over time, thereby improving future generation and verification of low-dimensional image 112.

With continued reference to FIG. 1, in some embodiments, computing device 104 may implement the image processing module, the segmentation module, and the validation module using one or more software libraries and/or machine learning frameworks. In some embodiments, computing device 104 may execute software libraries configured for image filtering, edge detection, contour extraction, geometric simplification, and rendering of colored contours on a uniform background. In some embodiments, such software libraries may implement operations such as gradient-based edge detection, contour tracing, spline fitting, and polygonal simplification. In some embodiments, computing device 104 may execute one or more machine learning frameworks configured to define, train, evaluate, and deploy the encoder-decoder models, segmentation models, and contrastive models described in this disclosure. In some embodiments, such a machine learning framework may manage learned parameters, intermediate feature maps, loss functions, optimization steps, and inference graph execution for real-time or near-real-time operation of computing device 104.

With continued reference to FIG. 1, in some embodiments, computing device 104 may train one or more models to generate, assess, and/or consume low-dimensional image 112. As used herein, an “encoder-decoder model” is a machine learning process that receives an input, produces an intermediate encoded representation, and reconstructs an output from that encoded representation. In some embodiments, computing device 104 may train an encoder-decoder model in which an encoder receives at least a radiological image 108 or a segmented representation and outputs an internal encoded representation that captures boundary geometry, and a decoder receives the internal encoded representation and outputs low-dimensional image 112, including a color-coded contour map. In some embodiments, training that encoder-decoder model may include adjusting internal parameters such as weights of convolutional filters, attention weights, node activation thresholds, and layer-to-layer connection parameters to reduce a loss function that measures difference between a generated low-dimensional image 112 and a target low-dimensional image 112 that has been previously validated. In some embodiments, computing device 104 may additionally train a contrastive model configured to embed low-dimensional image 112 into a feature space in which anatomically consistent views are located near one another, and anatomically inconsistent or low-quality outputs are located farther apart. In some embodiments, a contrastive model may learn internal weight values, bias values, and projection parameters so that frames representing the same anatomy under slightly different orientations cluster together and frames representing anatomically different regions separate. In some embodiments, training signals and validation results generated in this manner may be used by computing device 104 to automatically reject, flag, or request regeneration of any instance of low-dimensional image 112 that fails to preserve essential anatomical features of at least a radiological image 108.

With continued reference to FIG. 1, in some embodiments, the encoding module may generate low-dimensional image 112 by combining outputs of the image processing module, the segmentation module, the contour simplification and dimensionality reduction process, the color-coding process, and the validation module. In some embodiments, the image processing module may provide a conditioned version of at least a radiological image 108, the segmentation module may provide a segmented representation identifying anatomical boundaries, the contour simplification and dimensionality reduction process may generate a reduced contour set that expresses those boundaries as simplified lines with constrained line parameters, and the color-coding process may generate a color-coded contour map that assigns a color identifier to each simplified line. In some embodiments, the validation module may confirm that these simplified, color-coded lines preserve clinically relevant structure, and upon validation the encoding module may output low-dimensional image 112.

With continued reference to FIG. 1, in some embodiments, low-dimensional image 112 may be generated as a compressed anatomical representation of at least a radiological image 108. As used herein, a “compressed anatomical representation” is a representation that encodes anatomical structure using a constrained set of abstracted geometric elements rather than full image data. In some embodiments, a compressed anatomical representation may include a finite set of simplified lines, each line associated with a color identifier from a predefined color map, and may omit original texture, intensity distribution, speckle pattern, density information, grayscale values, or other raw imaging artifacts present in at least a radiological image 108. In some embodiments, low-dimensional image 112 may therefore include only essential anatomical contours extracted from a segmented representation, simplified into a reduced contour set, color coded according to anatomical identity using a color-coded contour map, and rendered against a uniform background. In some embodiments, essential anatomical contours may include boundaries of chambers, vessels, walls, tissue interfaces, procedural tools, implants, access paths, and/or other structures determined to be clinically relevant for navigation, interpretation, or guidance.

With continued reference to FIG. 1, in some embodiments, constraining low-dimensional image 112 to a limited set of simplified lines with associated line parameters and a limited set of color identifiers may allow computing device 104 to encode spatial organization of anatomy using substantially fewer stored values than would be required to store at least a radiological image 108. In some embodiments, this constraining may include limiting a total number of contours retained in low-dimensional image 112, limiting a total number of line parameters per contour after contour simplification and dimensionality reduction, and limiting a total number of color identifiers in the predefined color map. In some embodiments, by representing only structural boundaries in this compressed anatomical representation, low-dimensional image 112 may capture geometric relationships (for example, adjacency, orientation, curvature, or relative position of anatomical structures) while discarding modality-specific noise and intensity variation that are not required for downstream analysis. In some embodiments, low-dimensional image 112 may serve as standardized input to one or more machine learning processes executed by computing device 104. As used herein, a “standardized input” is an input that conforms to an expected structural format so that it can be consumed consistently by one or more machine learning processes. In some embodiments, a standardized input may include defined parameterization and a constrained set of allowable values such that multiple different acquisitions of at least a radiological image 108 (for example, from different imaging modalities, different hardware vendors, different operators, or different procedures) may be converted into comparable instances of low-dimensional image 112. In some embodiments, low-dimensional image 112 as a standardized input may be consumed by one or more self-supervised learning processes configured to learn structural features of anatomy without requiring frame-by-frame manual labeling. In some embodiments, low-dimensional image 112 may additionally be consumed by one or more predictive modeling processes configured to perform tasks such as anatomical classification, identification of a target structure, estimation of a likely instrument trajectory, inference of a procedural phase, determination of a next optimal imaging view, and/or generation of a simulated or future anatomical view. In some embodiments, predictive modeling may include training one or more models to map low-dimensional image 112 at a current time to a predicted low-dimensional image 112 at a subsequent time or different orientation, thereby enabling forecasting of structural changes, anticipated field of view, or likely device position using only the compressed anatomical representation rather than full-resolution instances of at least a radiological image 108.

With continued reference to FIG. 1, computing device 104 may be configured to input low-dimensional image 112 into at least a machine learning process 116. Machine learning process 116 may include any machine learning process described in this disclosure. In some cases, machine learning process 116 may include a self-supervised machine learning process 120. In some versions at least a line of low-dimensional image 112 may represent important anatomical structures and thus be used as implicit labelling for self-supervised learning. In some cases, at least a machine learning process 116 may include a generative machine learning process 124. Generative machine learning process may include any generative machine learning process described in this disclosure. Generative machine learning process may include a generative predictive transformer (GPT). In some embodiments, at least a computing device 104 may be configured to predict, at least a predicted low-dimensional image 132 as a function of the low-dimensional image. At least a predicted low-dimensional image may represent a new view (or pose) of a radiological image or a simulation of radiological images. As used herein, a “predicted low-dimensional image” is a low-dimensional image generated by at least a machine learning process as a function of a low-dimensional image. In some embodiments, a predicted low-dimensional image may depict a new anatomical view or pose of a target structure, such as a rotated view, a translated view, or a next-step procedural view, that computing device 104 forecasts using generative machine learning processes.

With continued reference to FIG. 1, as used herein, a “generative predictive transformer” is s a machine learning process implemented in software as a modular neural network architecture that includes (i) an embedding layer. The modular neural network architecture may include (i) an embedding layer, (ii) one or more transformer blocks, and (iii) an output projection layer that emits at least a predicted low-dimensional image 132 in the same representational format as low-dimensional image 112. In some embodiments, the embedding layer may receive low-dimensional image 112 and convert elements of low-dimensional image 112 (for example, line parameters of contours from a reduced contour set, associated color identifiers from a color-coded contour map, and identifiers of one or more target structures) into numeric feature vectors, and may append positional encodings. As used herein, a “positional encoding” is numeric information that represents spatial ordering and/or spatial locality so that downstream layers can interpret how different contours are arranged relative to each other. In some embodiments, the transformer blocks may each include a multi-head self-attention mechanism and one or more feedforward sublayers. As used herein, “self-attention” is computation of attention weights that indicate how strongly each embedded element should condition on other embedded elements in the same low-dimensional image 112. In some embodiments, each transformer block may generate queries, keys, and values from the embedded feature vectors, compute attention weights across those vectors, combine outputs across multiple attention heads, and apply a position-wise nonlinear feedforward network together with residual connections and normalization operations. In some embodiments, these transformer blocks may learn internal parameters, including weight matrices, bias values, attention weights, normalization parameters, and positional encodings, that capture spatial relationships among contours, color identifiers, and target structures present in low-dimensional image 112. In some embodiments, the output projection layer may receive an updated internal representation from the transformer blocks and emit at least a predicted low-dimensional image 132 in the same compressed anatomical representation format as low-dimensional image 112. In some embodiments, the output projection layer may output, for each predicted contour, predicted line parameters (for example, updated control point coordinates or spline coefficients), a predicted color identifier, and a predicted spatial relationship to other contours so that at least a predicted low-dimensional image 132 represents anatomy from a different pose, view, or timepoint without requiring direct acquisition of a corresponding instance of at least a radiological image 108. In some embodiments, training of the generative predictive transformer may include providing computing device 104 with pairs or sequences of low-dimensional image 112 samples and corresponding target predicted low-dimensional image 132 samples, and adjusting internal parameters of the embedding layer, transformer blocks, and output projection layer to minimize a difference between the emitted predicted low-dimensional image 132 and a reference predicted low-dimensional image 132. In some embodiments, by producing at least a predicted low-dimensional image 132 in this manner, computing device 104 may simulate an alternative imaging plane, a rotated or translated view, or a prospective procedural state of one or more target structures directly in the compressed anatomical representation domain.

With continued reference to FIG. 1, in some embodiments, the effect of inputting low-dimensional image 112 into at least a machine learning process 116 is that computing device 104 may use low-dimensional image 112 as a standardized input to learn anatomy, reason about anatomy, and predict anatomy without needing access to full raw instances of at least a radiological image 108. In some embodiments, because low-dimensional image 112 may include one or more lines that correspond to anatomically meaningful boundaries encoded with constrained line parameters and constrained color identifiers, low-dimensional image 112 may itself function as a labeled structural description of anatomy. In some embodiments, this may allow self-supervised machine learning process 120 to learn which anatomical structures are present and how those structures are arranged relative to one another without requiring frame-by-frame manual annotation. In some embodiments, this may further allow a generative machine learning process 124 to generate at least a predicted low-dimensional image 132 that represents a simulated or future anatomical view (for example, a different orientation, a next procedural pose, or a forecasted next frame) directly in the same compressed anatomical representation format. In some embodiments, computing device 104 may therefore use low-dimensional image 112 not only as a reduced description of anatomy already observed, but also as a basis for predicting what anatomy will look like under a different probe angle, catheter position, instrument maneuver, or imaging trajectory.

With continued reference to FIG. 1, in one or more embodiments, computing device 104 may implement one or more aspects of “generative artificial intelligence (AI),” a type of AI that uses machine learning algorithms to create, establish, or otherwise generate data such as, without limitation, predicted low-dimensional image 132 and/or the like in any data structure as described herein (e.g., text, image, video, audio, among others) that is similar to one or more provided training examples. In an embodiment, machine learning module described herein may generate one or more generative machine learning models that are trained on one or more set of low-dimensional images 112 and/or radiological images 108. One or more generative machine learning models may be configured to generate new examples that are similar to the training data of the one or more generative machine learning models but are not exact replicas; for instance, and without limitation, data quality or attributes of the generated examples may bear a resemblance to the training data provided to one or more generative machine learning models, wherein the resemblance may pertain to underlying patterns, features, or structures found within the provided training data.

Still referring to FIG. 1, in some cases, generative machine learning models may include one or more generative models. As described herein, “generative models” refers to statistical models of the joint probability distribution P (X, Y) on a given observable variable x, representing features or data that can be directly measured or observed (e.g., low-dimensional image 112) and target variable y, representing the outcomes or labels that one or more generative models aims to predict or generate (e.g., predicted low-dimensional image 132). In some cases, generative models may rely on Bayes theorem to find joint probability; for instance, and without limitation, Naïve Bayes classifiers may be employed by computing device 104 to categorize input data such as, without limitation, radiological images 108 and/or low-dimensional images 112 into different classes such as, without limitation, organ-based classification, cohort-based-classification, image-modality-based classification and the like.

In a non-limiting example, and still referring to FIG. 1, one or more generative machine learning models may include one or more Naïve Bayes classifiers generated, by computing device 104, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing Device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction.

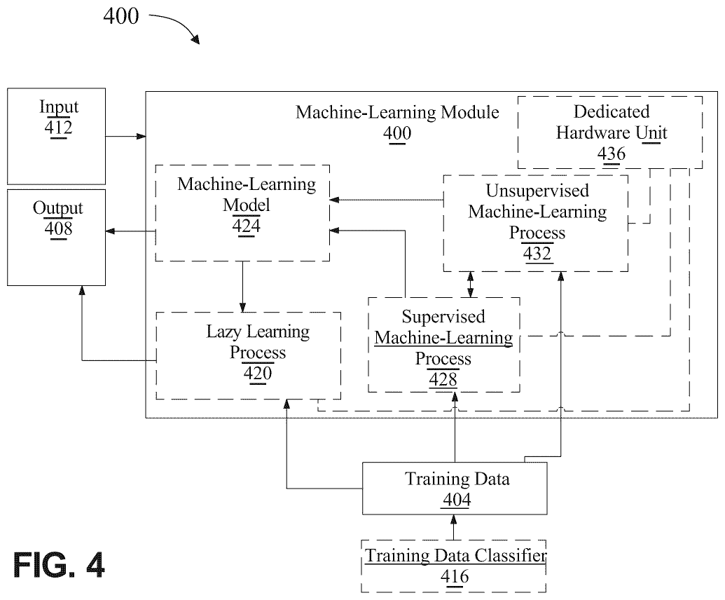

Still referring to FIG. 1, in some cases, one or more generative machine learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model as described in further detail with reference to FIG. 4.

With continued reference to FIG. 1, in an embodiment, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 4 to distinguish between different categories e.g., accurate vs. inaccurate or representative vs. non-representative, or states e.g., TRUE vs. FALSE within the context of generated data such as, without limitations, predicted low-dimensional image 132, and/or the like. In some cases, computing device 104 may implement one or more classification algorithms such as, without limitation, Support Vector Machines (SVM), Logistic Regression, Decision Trees, and/or the like to define decision boundaries.

In a non-limiting example, and still referring to FIG. 1, generator of GAN may be responsible for creating synthetic data that resembles real low-dimensional image 112. In some cases, GAN may be configured to receive low-dimensional image 112 such as, without limitation, encoded low-dimensional image 112 representing actual radiological image 108, as input and generates corresponding predicted low-dimensional image 132 containing information describing or evaluating the performance of one or more radiological image methodologies for imaging human anatomy. On the other hand, discriminator of GAN may evaluate the authenticity of the generated content by comparing it to real low-dimensional images 112, for example, discriminator may distinguish between genuine and generated content and providing feedback to generator to improve the model performance.

With continued reference to FIG. 1, in other embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

In a non-limiting example, and still referring to FIG. 1, VAE may be used by computing device 104 to model complex relationships between low-dimensional images 112. In some cases, VAE may encode input data into a latent space, capturing predicted low-dimensional images 132. Such encoding process may include learning one or more probabilistic mappings from observed radiological images 108 to a lower-dimensional latent representation, e.g., low-dimensional images 112. Latent representation may then be decoded back into the original data space, therefore reconstructing the low-dimensional images 112 and/or radiological images 108. In some cases, such decoding process may allow VAE to generate new examples or variations that are consistent with the learned distributions.

With continued reference to FIG. 1, in some embodiments, one or more generative machine learning models may be trained on a plurality of images and/or video as described herein, wherein the plurality of images and/or video may provide visual information that generative machine learning models analyze to understand the dynamics of medical imagery

Additionally, or alternatively, one or more generative machine learning models may utilize one or more predefined templates representing, for example, and without limitation, correct predicted low-dimensional image 132. In a non-limiting example, one or more low-dimensional image templates (i.e., predefined models or representations of correct and ideal low-dimensional images) may serve as benchmarks for comparing and evaluating plurality of low-dimensional images.

Still referring to FIG. 1, computing device 104 may configure generative machine learning models to analyze input data such as, without limitation, radiological images 108 and/or low-dimensional images 112 to one or more predefined templates such as low-dimensional image template representing correct low-dimensional images described above, thereby allowing computing device 104 to identify discrepancies or deviations from desired output. In some cases, computing device 104 may be configured to pinpoint specific errors in radiological images 108 and/or low-dimensional images or any other aspects of the input data. In a non-limiting example, computing device 104 may be configured to implement generative machine learning models to incorporate additional models to detect contours, lines, curves, and the like for instance in radiological images 108 and/or low-dimensional images. In some cases, errors may be classified into different categories or severity levels. In a non-limiting example, some errors may be considered minor, and generative machine learning model such as, without limitation, GAN may be configured to generate output data to contain only slight adjustments while others may be more significant and demand more substantial corrections. In some cases, one or more generative machine learning models may be configured to generate and output indicators such as, without limitation, visual indicator, audio indicator, and/or any other indicators as described above. Such indicators may be used to signal the detected error described herein.

Still referring to FIG. 1, in some cases, one or more generative machine learning models may also be applied by computing device 104 to edit, modify, or otherwise manipulate existing data or data structures. In an embodiment, output of training data used to train one or more generative machine learning models such as GAN as described herein may include low-dimensional images 108 and/or radiological images 112 that linguistically or visually demonstrate modified include low-dimensional images 108 and/or radiological images 112. In some cases, predicted low-dimensional image 132 may be synchronized with low-dimensional images 112, for example, and without limitation, a side-by-side or even overlayed arrangement with between input low-dimensional images 112 and predicted low-dimensional images 132.

With continued reference to FIG. 1, other exemplary embodiments of generative machine learning models may include, without limitation, long short-term memory networks (LSTMs), (generative pre-trained) transformer (GPT) models, mixture density networks (MDN), and/or the like. As an ordinary person skilled in the art, upon reviewing the entirety of this disclosure, will be aware of various generative machine learning models that may be used.

Still referring to FIG. 1, in a further non-limiting embodiment, machine learning module may be further configured to generate a multi-model neural network that combines various neural network architectures described herein. In a non-limiting example, multi-model neural network may combine LSTM for time-series analysis with GPT models for natural language processing. Such fusion may be applied by computing device 102 to generate predicted low-dimensional images 132. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others. As an ordinary person skilled in the art, upon reviewing the entirety of this disclosure, will be aware of various generative machine learning models that may be used to predict low-dimensional images and/or encode low-dimensional images, as described herein. As an ordinary person skilled in the art, upon reviewing the entirety of this disclosure, will be aware of various multi-model neural network and combination thereof that may be implemented by system 100 in consistent with this disclosure.

Still referring to FIG. 1, in some exemplary embodiments, aspects related to a novel encoding or representation of medical imaging data-specifically within frames derived from Transesophageal Echocardiography (TEE), Intracardiac Echocardiography (ICE), Transthoracic Echocardiography (TTE), or simulated CT-meshes.

Still referring to FIG. 1, in some exemplary embodiments, aspects relate to systems and methods to compress or otherwise efficiently represent radiological images in a way that allows for direct comparison between TEE/ICE/TTE frames and CT-derived 3D simulations. In some cases, Reducing dimensionality may allow for more rapid processing, for example to enable models to process and learn from large, complex image datasets more efficiently.

Still referring to FIG. 1, in some embodiments, system 100 additionally includes a display 136. Display 136 may be communicative with computing device 104 either through remote or local communication protocols and systems. Display may be configured to display one or more of output 128 of machine learning processes 116, low-dimensional image 112, and/or radiological image 108. Display may include any display described in this disclosure.

Still referring to FIG. 1, in some embodiments, system may be configured to receive at least a 3D radiological image 140, for example a CT scan image. Computing device may be configured to segment/encode at least a 3D low-dimensional image as a function of the 3D radiological image, segmentation/encoding may employ any steps/processes described in this disclosure including use of machine learning processes. Computing device 104 may be configured to align at least a 3D low-dimensional image 144 with at least a low-dimensional image 112. In some cases, computing device 104 may be configured to simulate at least a simulated low-dimensional image 148 as a function of at least a low-dimensional image 112 and at least a 3D low-dimensional image 144. Alignment of low-dimensional images 112 may include one or more transformations.

As an example, and still referring to FIG. 1, simple two dimensional translational transformations may be described using a vector (V) with two components Vx, Vy that describes displacement of blocks and/or pixels in an image. More complex transformations such as rotation, zooming, and warping may be described using affine transformations. Some exemplary affine transformations use four-parameter or six-parameter affine models.

For example, a six-parameter affine transformation may be described as:

$$\begin{matrix}x ’ = ax + b y + c \\ y ’ = dx + e y + f\end{matrix}$$

A four-parameter affine transformation may be described as:

$$\begin{matrix}x ’ = ax + b y + c \\ y ’ = - bx + a y + f\end{matrix}$$

where (x,y) and (x′,y′) are pixel locations in before and after transformation, respectively; a, b, c, d, e, and f are parameters of the affine motion model.

In some embodiments, systems and methods described in this disclosure may be used to generate synthetic radiological images, e.g., convert from low-dimensional image 112 and/or predicted low-dimensional image 132 to a synthetic radiological image. In some cases, synthetic radiological image may be shown to a user, doctor, patient or used to train machine learning models consistent with this disclosure. Exemplary systems and methods of producing certain synthetic radiological images (e.g., ultrasonic imagery) is described in detail in, co-owned, U.S. patent application Ser. Nos. 18/817,870 and 18/509,520 filed on Sep. 20, 2024, and Jul. 25, 2024, respectively and each titled “APPARATUS AND METHODS FOR SYNTHETIZING MEDICAL IMAGES,” the entirety of both applications is incorporated herein by reference.

Still referring to FIG. 1, in some exemplary embodiments, aspects relate to simulation-based on segmented CT mesh. In some cases, by aligning the TEE/ICE/TTE frames with a segmented CT mesh in a low-dimensional space, it becomes possible to simulate every feasible sensor trajectory and capture frames based on these virtual movements.

Still referring to FIG. 1, in some exemplary embodiments, aspects relate to use of self-supervised learning (SSL) and generative predictive transformers (GPT). In some cases, With these simulated sequences, you could apply SSL techniques to train models without needing a labeled dataset (since these would be simulations, the “label” would be inherent in the data). Using transformer models, like GPT, on these sequences could allow the model to predict future frames based on current trajectories, which would have strong applications in automated diagnostics or real-time guidance in medical settings.

Still referring to FIG. 1, in some exemplary embodiments, aspects relate to structured encoding strategy for echocardiography frames and CT-mesh-derived frames, for instance by transforming each into a low-dimensional space which may be defined by contours.

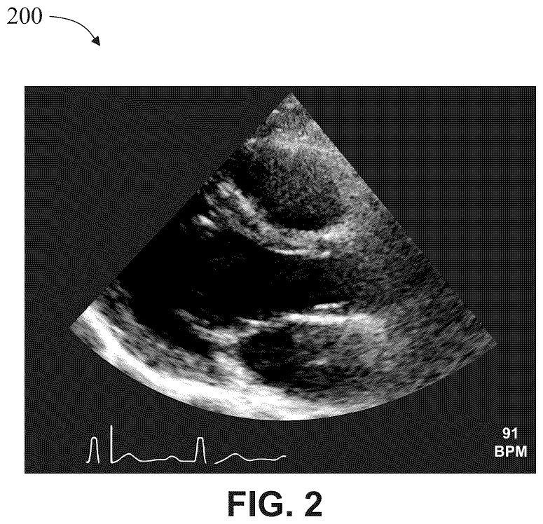

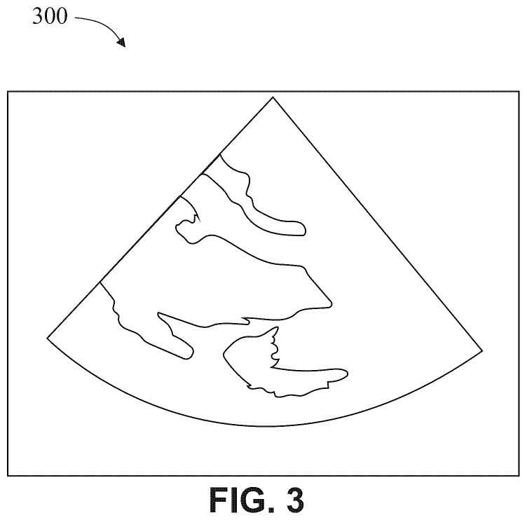

Referring now to FIGS. 2-3, exemplary radiological image 200 is shown in FIG. 2; and exemplary corresponding low-dimensional image 300 is shown in FIG. 3 (color-coding not shown). FIG. 2 shows an echocardiogram image. FIG. 3 represents the echocardiogram image shown in FIG. 2 within limited dimensionality.

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm instantiated in hardware or software logic, data structures, and/or functions that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example radiological images to low-dimensional images.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to radiological image type, e.g., ultrasound, CT imagery, and the like and or anatomy classification, e.g., heart, lungs, etc.

Still referring to FIG. 4, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. A computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 4, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 4, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 4, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 4, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 4, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 4, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 4, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 4, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 4, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{n e w} = \frac{X - {X}_{min}}{{X}_{max} - {X}_{min}}$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}}$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a a set or subset X_{median} and/or interquartile range (IQR), which represents the difference between the 25^{th} percentile value and the 50th percentile value (or closest values thereto by a rounding protocol), such as:

$${X}_{n e w} = \frac{X - {X}_{m e d i a n}}{IQR} .$$

Persons skilled in the art, upon reviewing the entirety of this disclosure, will be aware of various alternative or additional approaches that may be used for feature scaling.

Further referring to FIG. 4, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include low-dimensional images 112 and/or radiological images 108 as described above as inputs, radiological images 108 and/or low-dimensional images 112 as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

With further reference to FIG. 4, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 4, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 432 may not require a response variable; unsupervised processes 432 may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including, without limitation, support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 4, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 4, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 4, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 4, one or more processes or algorithms described above may be performed by at least a dedicated hardware unit 436. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 436 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 436 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 436 to perform one or more operations described herein, such as evaluation of model and/or algorithm outputs, one-time or iterative updates to parameters, coefficients, weights, and/or biases, and/or any other operations such as vector and/or matrix operations as described in this disclosure.

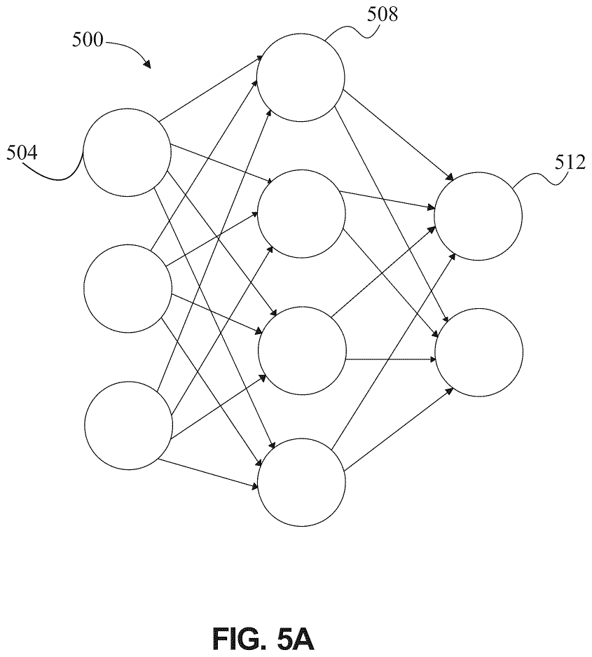

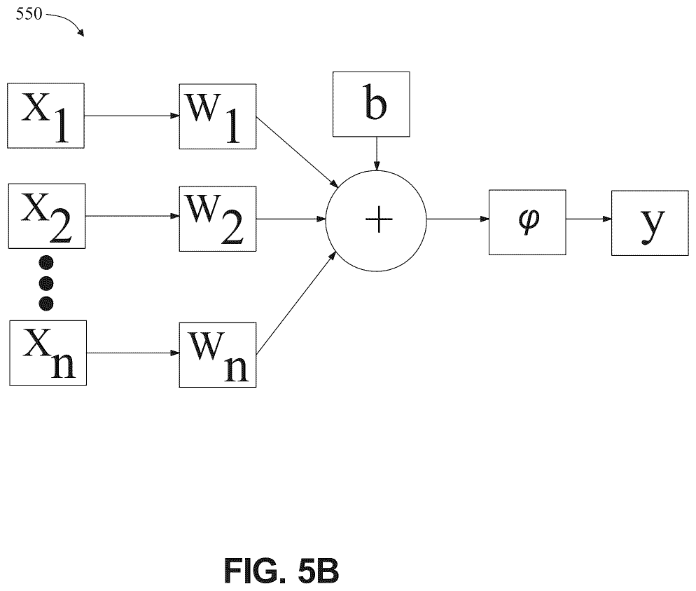

Referring now to FIG. 5A, an exemplary embodiment of neural network 500 is illustrated. A neural network 500 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 504, one or more intermediate layers 508, and an output layer of nodes 512. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 5B, an exemplary embodiment of a node 550 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input xᵢ a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a (1+tanh (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

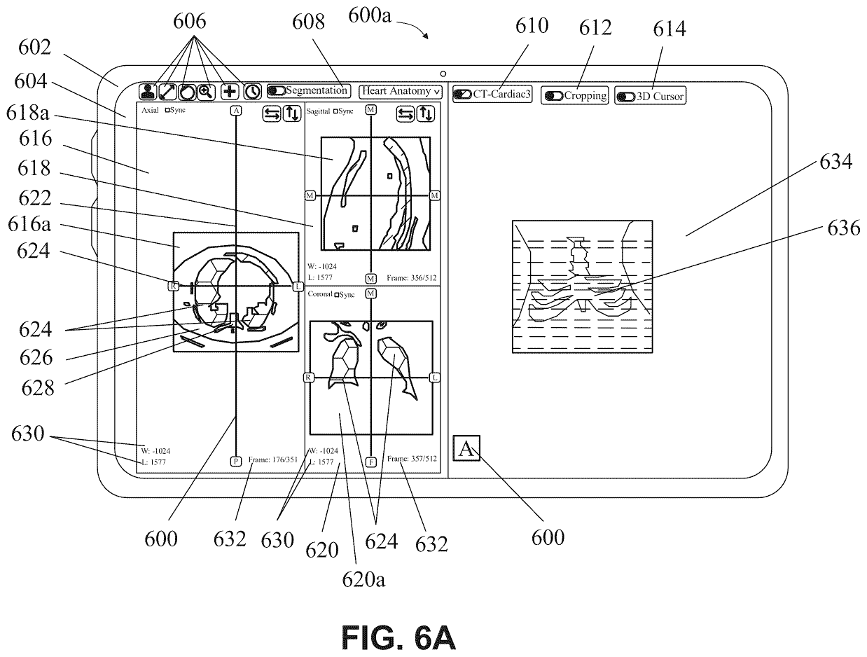

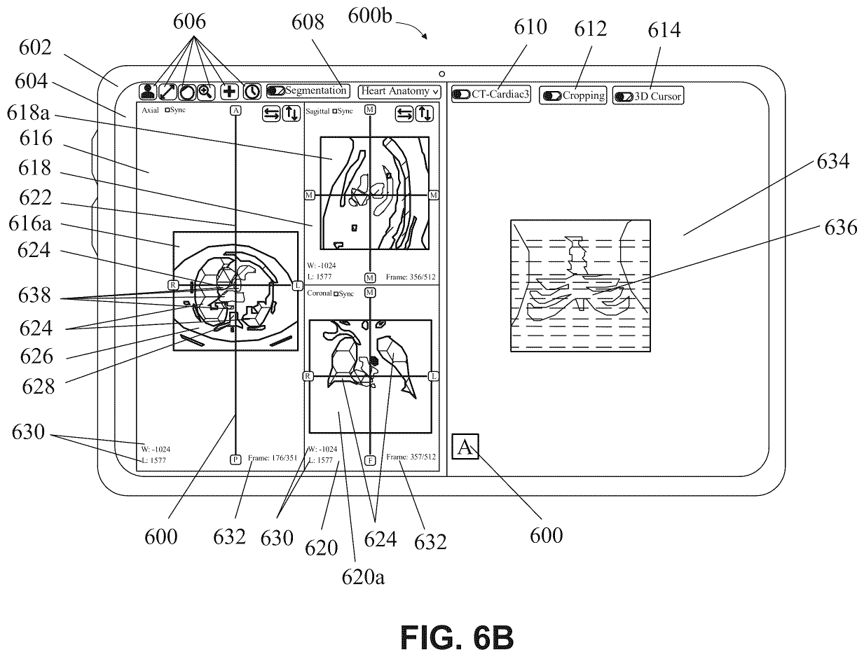

Referring now to FIG. 6A, an exemplary illustration, 600a of a graphical user interface displaying image data. Illustration 600a may depict a graphical user interface displaying image data derived from at least a radiological image 108, low-dimensional image 112, and/or at least a predicted low-dimensional image 132. In some embodiments, illustration 600a may be presented on a downstream device 602. As used herein, a “downstream device” is a device configured to receive outputs generated and displays those outputs for review, navigation, validation, and/or clinical use. In some embodiments, downstream device 602 may include a graphical user interface 604 that is configured to render one or more anatomical structures as contours, to present color-coded contour maps associated with low-dimensional image 112, to display at least a predicted low-dimensional image 132 corresponding to a simulated view, and/or to display a synthetic radiological image generated as a function of low-dimensional image 112 and/or at least a predicted low-dimensional image 132. In some embodiments, graphical user interface 604 may be configured to allow a user to inspect, compare, or interact with anatomical representations produced by computing device 104, including reviewing correspondence between anatomical structures in at least a radiological image 108 and the compressed anatomical representation encoded in low-dimensional image 112.

With continued reference to FIG. 6A, in an embodiment, the graphical user interface 604 may display one or more widgets 606. As used in this disclosure, a “widget” is a graphical user interface element configured to provide interactive functionality within a display environment. Without limitation, a widget 606 may include buttons, sliders, dropdown menus, checkboxes, icons, interactive panels, and the like. In an embodiment, a widget 606 may enable a user to manipulate, filter, or navigate candidate frames or views of target structures. In an embodiment, widgets 606 may also provide functionality for adjusting visualization parameters such as brightness, contrast, zoom, or viewpoint. In a non-limiting example, a widget 606 may allow a clinician to toggle between segmented labels of the mitral valve and left atrium in a displayed frame.

With continued reference to FIG. 6A, in an embodiment, the graphical user interface 604 may display a segmentation toggle 608. As used in this disclosure, a “segmentation toggle” is a graphical user interface widget configured to enable or disable the display of segmented labels within image data. Without limitation, the segmentation toggle 608 may allow a user to switch between raw imaging views and segmented views where anatomical substructures are highlighted or color-coded. In an embodiment, the segmentation toggle 608 may be used to visualize structures such as the left atrium, right ventricle, or mitral valve with labeled overlays. In a non-limiting example, activating the segmentation toggle 608 may cause the system to display CT slices with boundaries of the coronary arteries outlined, while deactivating the segmentation toggle 608 may show the original grayscale image. In some embodiments, activation of the segmentation toggle 608 may additionally cause graphical user interface 604 to display contours and color assignments derived from low-dimensional image 112 or at least a predicted low-dimensional image 132 so that a user can visually confirm which anatomical structures are preserved in the compressed anatomical representation and how those structures correspond to at least a radiological image 108.

With continued reference to FIG. 6A, in an embodiment, the graphical user interface 604 may display a CT-Cardiac3 toggle 610. As used in this disclosure, a “CT-Cardiac3 toggle” is a graphical user interface widget configured to switch the display mode of the apparatus to a predefined imaging protocol, dataset, or visualization configuration associated with cardiac CT data. Without limitation, the CT-Cardiac3 toggle 610 may activate specific windowing parameters, orientations, or frame selections optimized for viewing cardiac structures. In an embodiment, the CT-Cardiac3 toggle 610 may load a particular reconstruction protocol such as CT-Cardiac3, displaying frames in coronal, sagittal, or axial views with appropriate contrast settings. In a non-limiting example, a user may activate the CT-Cardiac3 toggle 610 to display CT slices optimized for visualizing coronary arteries, chambers, and valves.

With continued reference to FIG. 6A, in an embodiment, the graphical user interface 604 may display a cropping toggle 612. As used in this disclosure, a “cropping toggle” is a graphical user interface widget configured to activate or deactivate cropping functions within the display of medical imaging data. Without limitation, the cropping toggle 612 may allow a user to remove or hide irrelevant regions of an image, thereby focusing visualization on the target structure. In an embodiment, the cropping toggle 612 may permit real-time adjustment of boundaries, allowing clinicians to isolate structures such as the aortic root or pulmonary veins. In a non-limiting example, activating the cropping toggle 612 may allow a user to crop away surrounding lung tissue in a CT dataset to focus exclusively on the cardiac silhouette.

With continued reference to FIG. 6A, in an embodiment, the graphical user interface 604 may display a 3D cursor toggle 614. As used in this disclosure, a “3D cursor toggle” is a graphical user interface widget configured to activate or deactivate a three-dimensional cursor within displayed image data. Without limitation, the 3D cursor toggle 614 may allow a user to place or move a cursor within volumetric imaging datasets or 3D mesh reconstructions. In an embodiment, the 3D cursor toggle 614 may assist in selecting anatomical landmarks, measuring distances, or orienting views across multiple planes. In a non-limiting example, activating the 3D cursor toggle 614 may allow a clinician to pinpoint the location of the aortic valve in a 3D mesh and simultaneously highlight the corresponding point in axial, sagittal, and coronal views.

With continued reference to FIG. 6A, in an embodiment, the graphical user interface 604 may display an axial view window 616. As used in this disclosure, an “axial view window” is a graphical user interface element configured to display imaging data in the axial plane. Without limitation, the axial view window 616 may show cross-sectional slices of the body from head to foot. In an embodiment, the axial view window 616 may display frames of cardiac CT or MRI that provide a top-down view of cardiac anatomy. In a non-limiting example, the axial view window 616 may display cross-sections of the left and right ventricles at different levels of the heart.

With continued reference to FIG. 6A, in an embodiment, the graphical user interface 604 may display an axial image view 616a. As used in this disclosure, an “axial image view” is a graphical user interface element configured to display an individual frame or slice within the axial view window 616. Without limitation, the axial image view 616a may show a single cross-sectional image of the body oriented in the axial plane. In an embodiment, the axial image view 616a may display either raw image data or segmented image data with labeled anatomical substructures. In an embodiment, the axial image view 616a may highlight target structures relevant to a user query. In a non-limiting example, the axial image view 616a may display a CT slice at the mid-ventricular level, with overlays labeling the left ventricle, right ventricle, and interventricular septum. In another non-limiting example, the axial image view 616a may display an MRI slice of the atria, wherein the pulmonary veins are segmented and color coded. In another non-limiting example, the axial image view 616a may display a cine frame from echocardiography reformatted into the axial plane, showing systolic contraction of the left ventricle.

With continued reference to FIG. 6A, in an embodiment, the graphical user interface 604 may display a sagittal view window 618. As used in this disclosure, a “sagittal view window” is a graphical user interface element configured to display imaging data in the sagittal plane. Without limitation, the sagittal view window 618 may show slices that divide the body into left and right portions. In an embodiment, the sagittal view window 618 may display frames of the heart oriented from side-to-side, allowing visualization of anterior-posterior relationships of structures. In a non-limiting example, the sagittal view window 618 may display a profile view of the left atrium, mitral valve, and left ventricle.

With continued reference to FIG. 6A, in an embodiment, the graphical user interface 604 may display a sagittal image view 618a. As used in this disclosure, a “sagittal image view” is a graphical user interface element configured to display an individual sagittal frame or slice within the sagittal view window. Without limitation, the sagittal image view 618a may present segmented or unsegmented images of anatomical substructures. In an embodiment, the sagittal image view 618a may highlight labeled structures within a single sagittal slice, such as the interventricular septum or aortic outflow tract. In a non-limiting example, the sagittal image view 618a may display a single CT slice where both the left atrial appendage and pulmonary veins are visible in profile.

With continued reference to FIG. 6A, in an embodiment, the graphical user interface 604 may display a coronal view window 620. As used in this disclosure, a “coronal view window” is a graphical user interface element configured to display imaging data in the coronal plane. Without limitation, the coronal view window 620 may show slices that divide the body into anterior and posterior portions. In an embodiment, the coronal view window 620 may be used to visualize cardiac anatomy from a front-facing orientation. In a non-limiting example, the coronal view window 620 may display slices of the atria, ventricles, and great vessels as they appear when viewed from the anterior chest.

With continued reference to FIG. 6A, in an embodiment, the graphical user interface 604 may display a coronal image view 620a. As used in this disclosure, a “coronal image view” is a graphical user interface element configured to display an individual coronal slice or frame within the coronal view window. Without limitation, the coronal image view 620a may show raw, segmented, or annotated imaging data. In an embodiment, the coronal image view 620a may highlight anatomical substructures, such as the pulmonary veins entering the left atrium or the orientation of the mitral and tricuspid valves. In a non-limiting example, the coronal image view 620a may display a single CT slice where both atria and the proximal ascending aorta are visible.

With continued reference to FIG. 6A, in an embodiment, the graphical user interface 604 may display a y-axis 622. As used in this disclosure, a “y-axis” is a graphical user interface element representing the vertical orientation within a displayed image or window. Without limitation, the y-axis 622 may provide spatial reference for measurements, annotations, or alignment across imaging planes. In an embodiment, the y-axis 622 may be used to indicate superior-to-inferior direction in an axial view or cranial-to-caudal orientation in coronal and sagittal views. In a non-limiting example, the y-axis 622 may assist in identifying whether a structure, such as the left ventricle, is located higher or lower relative to adjacent anatomical features.

With continued reference to FIG. 6A, in an embodiment, the graphical user interface 604 may display an x-axis 624. As used in this disclosure, an “x-axis” is a graphical user interface element representing the horizontal orientation within a displayed image or window. Without limitation, the x-axis 624 may provide spatial reference for measurements, annotations, or alignment across imaging planes. In an embodiment, the x-axis 624 may be used to indicate left-to-right orientation in axial or coronal views. In a non-limiting example, the x-axis 624 may assist in determining whether the right atrium lies lateral to the left atrium in a coronal frame.

With continued reference to FIG. 6A, in an embodiment, the graphical user interface 604 may display a first anatomical feature 626. As used in this disclosure, a “first anatomical feature” is a displayed portion of the body represented within the graphical user interface that corresponds to an anatomical structure, substructure, or tissue. Without limitation, a first anatomical feature 626 may include skeletal elements, such as bone, soft tissue, such as myocardium or muscle, or surface tissue, such as skin. In an embodiment, the first anatomical feature 626 may be displayed in one or more imaging views, including axial, sagittal, or coronal frames. In a non-limiting example, the first anatomical feature 626 may include the myocardium of the left ventricle segmented and displayed within a CT or MRI dataset.

With continued reference to FIG. 6A, in an embodiment, the graphical user interface 604 may display a second anatomical feature 628. As used in this disclosure, a “second anatomical feature” is a displayed portion of the body represented within the graphical user interface that corresponds to a different anatomical structure, substructure, or tissue than the first anatomical feature. Without limitation, the second anatomical feature 628 may include bone, connective tissue, vasculature, or skin. In an embodiment, the second anatomical feature 628 may be displayed simultaneously with or adjacent to the first anatomical feature, allowing visualization of their spatial relationship. In a non-limiting example, the second anatomical feature 628 may include the sternum displayed alongside segmented cardiac tissue, enabling visualization of the heart's position relative to the chest wall.

With continued reference to FIG. 6A, in an embodiment, the graphical user interface 604 may display a location indicator 630. As used in this disclosure, a “location indicator” is a graphical user interface element configured to display windowing parameters associated with the visualization of medical imaging data. Without limitation, the location indicator 630 may include a window width value and a window level value, denoted as W and L, respectively. In an embodiment, the location indicator 630 may provide real-time feedback on the brightness and contrast settings applied to a displayed frame, enabling precise visualization of anatomical features. In a non-limiting example, a location indicator 630 may display W: −1024, L: 1577, representing a narrow window width centered at a high level, thereby enhancing visualization of high-density structures such as calcified bone. In another non-limiting example, a location indicator 630 may display W: 400, L: 40, corresponding to soft tissue windowing parameters optimized for cardiac structures such as myocardium or chambers. In another non-limiting example, a location indicator 630 may display W: 1500, L: −600, corresponding to lung window settings for CT scans, allowing clear visualization of pulmonary tissue surrounding the heart. In an embodiment, the location indicator 630 may be dynamically adjustable, wherein user interaction with the graphical user interface updates the W and L values in real time, and the displayed candidate frames are refreshed accordingly.

With continued reference to FIG. 6A, in an embodiment, the graphical user interface 604 may display a frame number 632. As used in this disclosure, a “frame number” is a graphical user interface element that identifies the index of a displayed frame within a sequence of frames. Without limitation, a frame number 632 may correspond to temporal position in a cine loop, spatial index in a CT or MRI volume, or sequential order in a reconstructed dataset. In an embodiment, a frame number 632 may assist users in tracking progression through a dataset or returning to a specific frame. In a non-limiting example, a frame number 632 may display “frame 68 of 200” in a CT dataset of the thorax.

With continued reference to FIG. 6A, in an embodiment, the graphical user interface 604 may display a right window 634. As used in this disclosure, a “right window” is a graphical user interface element configured to display imaging data, annotations, or controls in a panel on the right-hand portion of the display. Without limitation, the right window 634 may present supplementary views, metadata, or multimodal overlays. In an embodiment, the right window 634 may display corresponding sagittal slices while the main panel shows coronal views, or may provide an annotation panel for user-entered notes. In a non-limiting example, the right window 634 may display candidate frames of the aortic root while the central panel shows a 3D mesh rendering.

With continued reference to FIG. 6A, in an embodiment, the graphical user interface 604 may display a volume rendering 636. As used in this disclosure, a “volume rendering” is a computational technique configured to generate a three-dimensional visualization from volumetric imaging data. Without limitation, the volumetric imaging data may include computed tomography (CT) or magnetic resonance imaging (MRI). Without limitation, volume rendering 636 may incorporate intensity values, opacity functions, and color mapping to represent internal structures within a volumetric dataset. In an embodiment, volume rendering 636 may be used to visualize both surface features and internal anatomy simultaneously, providing depth and spatial context not available in two-dimensional projections. In a non-limiting example, CT-derived volumetric data of the thorax may be rendered to display the heart and associated anatomical structures, including the chambers, valves, coronary vessels, and surrounding tissue, in a three-dimensional representation.

Referring now to FIG. 6B, an exemplary illustration 600b of a graphical user interface displaying image data including a target structure. In an embodiment, the graphical user interface 604 may display one or more target structures 638. As used herein, a “target structure” is an anatomical structure, anatomical substructure, device structure, or clinically relevant region of interest. Without limitation, the one or more target structures 638 may be the same or substantially similar to the target structure as defined in FIG. 1. In an embodiment, the one or more target structures may be color coded to visually differentiate them from surrounding anatomy or from each other. In an embodiment, color coding may be applied to segmentation masks, overlays, or three-dimensional renderings. In a non-limiting example, the left atrium may be displayed in red, the left ventricle in blue, and the pulmonary veins in green, allowing a user to rapidly identify the spatial relationship between these target structures. In another non-limiting example, coronary arteries may be highlighted in yellow while the myocardium is displayed in purple, improving visualization of vessel paths against myocardial tissue. In another non-limiting example, a pathology such as a thrombus may be displayed in orange to distinguish it from both the blood pool and the cardiac chambers. In an embodiment, color coding of target structures may be user configurable, wherein the graphical user interface provides widgets or toggles to adjust the assigned colors. In an embodiment, consistent color schemes may be applied across views and modalities, ensuring that a target structure such as the mitral valve is represented in the same color whether displayed in axial slices, sagittal slices, or 3D volume renderings.

With continued reference to FIG. 6B, in some embodiments, identifying and displaying a target structure 638 may be directly supported by low-dimensional image 112 and at least a predicted low-dimensional image 132. In some embodiments, computing device 104 may determine which anatomical regions qualify as a target structure 638 by analyzing contours and color assignments present in low-dimensional image 112, where each contour is already associated with a structure identifier through the segmented representation and reduced contour set. In some embodiments, computing device 104 may propagate that same target structure 638 through at least a predicted low-dimensional image 132 so that graphical user interface 604 may show not only where the target structure 638 is in a current view derived from at least a radiological image 108, but also where the target structure 638 is expected to appear in a simulated or future view generated by a generative machine learning process 124. In some embodiments, this allows graphical user interface 604 to highlight, color code, and track a target structure 638 consistently across modalities, across planes (for example axial, sagittal, coronal), and across predicted poses, using the same compressed anatomical representation that computing device 104 uses for machine learning. Further examples of illustration 600 may include embodiments disclosed in, co-owned, U.S. patent application Ser. No. 19/359,267 filed on Oct. 15, 2025, respectively and each titled “APPARATUS AND METHOD FOR DETERMINING ONE OR MORE CANDIDATE FRAMESCOMPRISING CARDIAC ANATOMY,” the entirety of which is incorporated herein by reference.

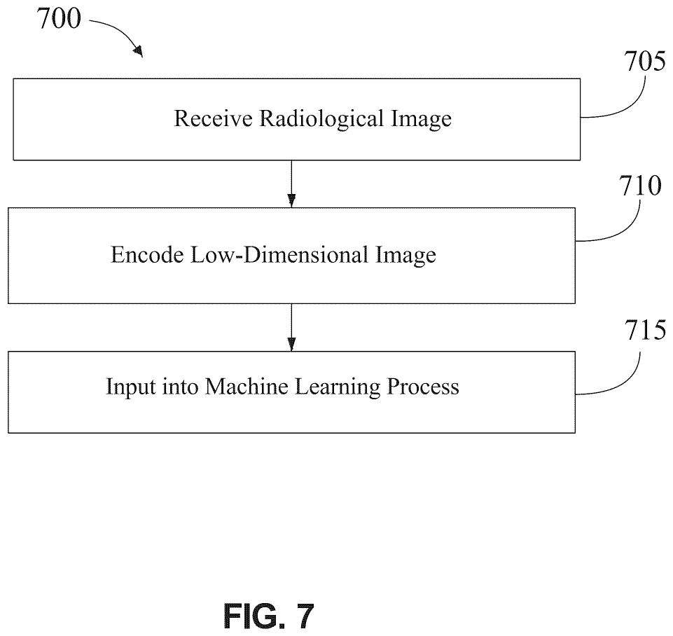

Referring now to FIG. 7, a flowchart is shown showing a method 700 according to some embodiments. Method 700 may include process, embodiments, and systems as disclosed herein and above, and with reference to FIGS. 1-5, 6A and 6B. At step 705, method 700 includes receiving, by a computing device, at least a radiological image. At step 710, method 700 includes encoding, by the computing device, using an encoding module, a low-dimensional image as a function of the radiological image, wherein there encoding module is configured to preprocess the radiological image; generate a segmented representation of the radiological image by applying edge detection to the preprocessed radiological image; generate a reduced contour set by performing contour simplification and dimensionality reduction on the segmented representation; and generating color-coded contour map by coloring coding one or more contours of the reduced contour set. At step 715, method 700 includes inputting, by the computing device, the low-dimensional image into at least a machine learning process as training data

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

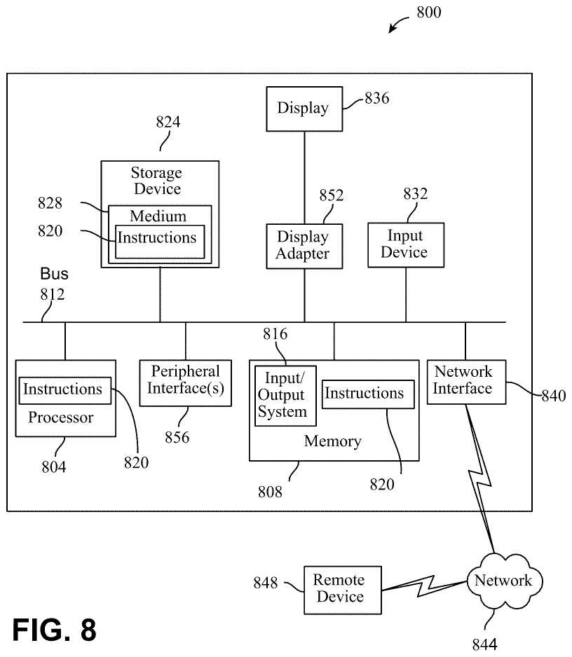

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display 836. Examples of a display device include, but are not limited to, a liquid crystal display (LCD), a cathode ray tube (CRT), a plasma display, a light emitting diode (LED) display, and any combinations thereof. Display adapter 852 and display 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for encoding a low-dimensional image comprising;
at least a computing device configured to:
receive at least a radiological image;
encode, using an encoding module, a low-dimensional image as a function of the radiological image, wherein the encoding module is configured to:
preprocess the radiological image;
generate a segmented representation of the radiological image by applying edge detection to the preprocessed radiological image;
generate a reduced contour set by performing contour simplification and dimensionality reduction on the segmented representation; and
generate a color-coded contour map by coloring coding one or more contours of the reduced contour set; and
input the low-dimensional image into at least a machine learning process as training data.

2. The system of claim 1, wherein preprocessing the radiological image comprises performing:
noise reduction by applying a median filter to replace an intensity value at a pixel location with a median intensity value taken from a defined neighborhood around that pixel location; and
contrast enhancement including histogram equalization to improve visual salience of thin anatomical features that appear faint in the radiological image.

3. The system of claim 1, wherein the encoding module is further configured to validate the low-dimensional image using an encoder-decoder model to reconstruct the radiological image from the low-dimensional image, wherein differences between the reconstructed radiological image and the received at least a radiological image are used to score adequacy of the low-dimensional image.

4. The system of claim 1, wherein generating the segmented representation comprises implementing a segmentation module of the encoding module configured to perform contour detection and extraction based on detected edges of the preprocessed radiological image.

5. The system of claim 1, wherein the machine learning process comprises a generative machine learning process.

6. The system of claim 5, wherein the generative machine learning process comprises a generative predictive transformer configured to predict at least one predicted low-dimensional image as a function of least one low-dimensional image.

7. The system of claim 1, wherein the radiological image comprises at least an ultrasound image.

8. The system of claim 1, wherein the radiological image comprises one or more of a computed tomography image, a magnetic resonance imaging image, an X-ray image, a fluoroscopy image, and photoacoustic image.

9. The system of claim 1, wherein contour simplification comprises modifying one or more contours in the radiological image so that each contour is represented using fewer points while preserving clinically relevant geometric structure.

10. The system of claim 1, wherein dimensionality reduction comprises transforming data describing one or more contours from a higher-dimensional coordinate description into a lower-dimensional description that preserves salient geometric relationship.

11. A method of encoding a low-dimensional image, the method comprising:
receiving, by a computing device, at least a radiological image;
encoding, by the computing device, using an encoding module, a low-dimensional image as a function of the radiological image by:
preprocessing the radiological image;
generating a segmented representation of the radiological image by applying edge detection to the preprocessed radiological image;
generating a reduced contour set by performing contour simplification and dimensionality reduction on the segmented representation; and
generating a color-coded contour map by coloring coding one or more contours of the reduced contour set; and
inputting, by the computing device, the low-dimensional image into at least a machine learning process as training data.

12. The method of claim 11, wherein preprocessing the radiological image comprises performing:
noise reduction by applying a median filter to replace an intensity value at a pixel location with a median intensity value taken from a defined neighborhood around that pixel location; and
contrast enhancement including histogram equalization to improve visual salience of thin anatomical features that appear faint in the radiological image.

13. The method of claim 11, wherein the encoding module is further configured to validate the low-dimensional image using an encoder-decoder model to reconstruct the radiological image from the low-dimensional image, wherein differences between the reconstructed radiological image and the received at least a radiological image are used to score adequacy of the low-dimensional image.

14. The method of claim 11, wherein generating the segmented representation comprises implementing a segmentation module of the encoding module configured to perform contour detection and extraction based on detected edges of the preprocessed radiological image.

15. The method of claim 11, wherein the machine learning process comprises a generative machine learning process.

16. The method of claim 15, wherein the generative machine learning process comprises a generative predictive transformer configured to predict at least one predicted low-dimensional image as a function of least one low-dimensional image.

17. The method of claim 11, wherein the radiological image comprises at least an ultrasound image.

18. The method of claim 11, wherein the radiological image comprises one or more of a computed tomography image, a magnetic resonance imaging image, an X-ray image, a fluoroscopy image, and photoacoustic image.

19. The method of claim 11, wherein contour simplification comprises modifying one or more contours in the radiological image so that each contour is represented using fewer points while preserving clinically relevant geometric structure.

20. The method of claim 11, wherein dimensionality reduction comprises transforming data describing one or more contours from a higher-dimensional coordinate description into a lower-dimensional description that preserves salient geometric relationship.
